(19) United States
(12) Patent Application Publication
(10) Pub. No.: US 2018/0357536 A1
(43) Pub. Date: Dec. 13, 2018

(54) SYSTEM FOR RECOGNIZING BEATING PATTERN AND METHOD FOR RECOGNIZING THE SAME

(71) Applicants: HYUNDAI MOTOR COMPANY, Seoul (KR); KIA MOTORS CORPORATION, Seoul (KR); SOGANG UNIVERSITY RESEARCH FOUNDATION, Seoul (KR)

(72) Inventors: Hui Sung LEE, Gunpo-Si (KR); Hyung Min PARK, Seoul (KR); Young Man KIM, Cheongju-si (KR)

(21) Appl. No.: 15/820,927

(22) Filed: Nov. 22, 2017

(30) Foreign Application Priority Data
Jun. 12, 2017 (KR) 10-2017-0073142

(51) Int. Cl. G06N 3/08; G06N 3/04; G06N 5/04

(52) U.S. Cl. CPC G06N 3/08; G06N 5/047; G06N 3/04

(57) ABSTRACT

A beating pattern recognition system includes: a preprocessor preprocessing an input signal; a deep neural network learning processor including a plurality of deep neural networks and performing learning to classify an input type of the input signal; and a classification processor classifying the input type of the preprocessed input signal using the learned deep neural network.

### CROSS-REFERENCE TO RELATED APPLICATION

This application is based on and claims the benefit of priority to Korean Patent Application No. 10-2017-0073142, filed on Jun. 12, 2017, in the Korean Intellectual Property Office, the disclosure of which is incorporated herein in its entirety by reference.

### TECHNICAL FIELD

The present disclosure relates to a system and a method for recognizing a beating pattern, and more particularly, relates to a system and a method for recognizing a beating pattern, which are capable of classifying a beating pattern generated in a vehicle based on a deep neural network.

### BACKGROUND

In a conventional pattern recognition system, one deep neural network is used to classify data into various output groups all at once. Thus, as the number of output groups to be classified increases with respect to a limited number of data, an overall performance of the pattern recognition system is deteriorated. Especially, a beating signal has features which are quite different from those of a normal sound signal. Accordingly, it is difficult to apply a feature extraction algorithm (MFCC, Mel-energy) of a sound signal or a transfer learning technology that pre-learns the deep neural network with respect to a voice data, which are conventionally used in general. Due to the above-described difficulties, the recognition performance on a beating pattern with a limited number of data is not good enough to commercialize the beating pattern.

Moreover, in the conventional pattern recognition system, a part that extracts features required to recognize a pattern is separated from a part that recognizes the pattern based on the extracted result. Thus, it is troublesome for the user to analyze multiple input signals, extract a feature of the input signal appropriate for the pattern recognition, and specify a corresponding feature. Particularly, in case of the beating pattern in a vehicle, the feature of the beating pattern is changed in accordance with the types of the vehicle. Thus, when the types of the vehicle are changed, an additional development for extracting a feature appropriate for the new vehicle type is required.

### SUMMARY

The present disclosure has been made to solve the above-mentioned problems occurring in the prior art while advantages achieved by the prior art are maintained intact.

An aspect of the present disclosure provides, when a beating pattern is recognized by using a deep neural network, a system and a method for recognizing the beating pattern to prevent a performance required to recognize the beating pattern from degrading since the deep neural network becomes complex as the deep neural network is required to classify patterns having features different from each other all at once and an amount of data for appropriately recognizing the complex deep neural network is not sufficient.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a beating pattern recognition system includes a preprocessor that preprocesses an input signal, a deep neural network learning processor that includes a plurality of deep neural networks and performs learning to classify an input type of the input signal, and a classification processor that classifies the input type of the preprocessed input signal using the learned deep neural network.

The preprocessor preprocesses the input signal using a log power spectra (LPS) as a spectrum analysis technology.

The preprocessor determines frames in a predetermined range of front and rear with respect to a frame, in which an energy of the input signal is highest, as valid signals.

The deep neural network learning processor relearns a result of the input type of the input signal classified by the classification processor.

The deep neural network learns the classification of the input signal using a rectified linear unit (ReLU) activation function or a drop-out.

The deep neural network includes an input layer, a hidden layer, and an output layer, and a number of nodes of the output layer is varied depending on a number of results that are to be classified by the classification processor.

The classification processor performs a primary classification that classifies the input signal into a beating input signal by a user and a noise signal, performs a secondary classification that classifies signals classified as the beating input signal by the user in the primary classification into one of an external input and an internal input, and performs a tertiary classification that classifies each of the external input and the internal input with respect to the input type of the input signal.

The deep neural network learning processor duplicates data including the input signal or adds the noise signal to the data such that the number of the data becomes uniform in each of the primary, secondary, and tertiary classifications to learn the deep neural network.

The deep neural network learns such that the deep neural network classifies the input signal with respect to different references in each of the primary, secondary, and tertiary classifications.

The tertiary classification classifies the external input with respect to the input type into one of a finger joint, a fist, and an elbow.

The tertiary classification classifies the internal input with respect to the input type into one of a finger joint and a fingertip.

According to another aspect of the present disclosure, a beating pattern recognition method includes preprocessing an input signal, learning a plurality of deep neural networks to classify an input type of the input signal, and classifying the input type of the preprocessed input signal using the learned deep neural network.

The preprocessing the input signal includes preprocessing the input signal using a log power spectra (LPS) as a spectrum analysis technology.

The preprocessing the input signal includes determining frames in a predetermined range of front and rear with respect to a frame, in which an energy of the input signal is highest, as valid signals.

The classifying the input type of the input signal includes primarily classifying the input signal into a beating input signal by a user and a noise signal, secondarily classifying signals classified as the beating input signal by the user in the primary classification into one of an external input and an internal input, and tertiarily classifying each of the external input and the internal input with respect to the input type of the input signal.

The tertiarily classifying includes classifying the external input with respect to the input type into one of a finger joint, a fist, and an elbow.

The tertiarily classifying includes classifying the internal input with respect to the input type into one of a finger joint and a fingertip.

The learning to classify the input type of the input signal includes relearning a result of the input type of the classified input signal.

The learning to classify the input type of the input signal includes learning classification of the input signal using a rectified linear unit (ReLU) activation function or a drop-out.

The learning to classify the input type of the input signal includes duplicating data comprising the input signal or adding the noise signal to the data such that the number of the data becomes uniform in each of the primary, secondary, and tertiarily classifications to learn the deep neural network.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a beating pattern recognition system according to an exemplary embodiment of the present disclosure;

FIG. 2 is a schematic view illustrating a deep neural network according to an exemplary embodiment of the present disclosure;

FIG. 3 is a flowchart illustrating a method of recognizing a beating pattern according to an exemplary embodiment of the present disclosure; and

FIG. 4 is a block diagram illustrating a configuration of a computing system that executes a method for recognizing a beating pattern according to an exemplary embodiment of the present disclosure.

### DETAILED DESCRIPTION

Hereinafter, exemplary embodiments of the present disclosure will be described in detail with reference to the accompanying drawings. In the drawings, the same reference numbers will be used throughout to designate the same or equivalent elements. In addition, a detailed description of well-known features or functions will be ruled out in order not to unnecessarily obscure the gist of the present disclosure.

In describing elements of exemplary embodiments of the present disclosure, the terms 1^{st}, 2^{nd}, first, second, A, B, (a), (b), and the like may be used herein. These terms are only used to distinguish one element from another element, but do not limit the corresponding elements irrespective of the order or priority of the corresponding elements. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

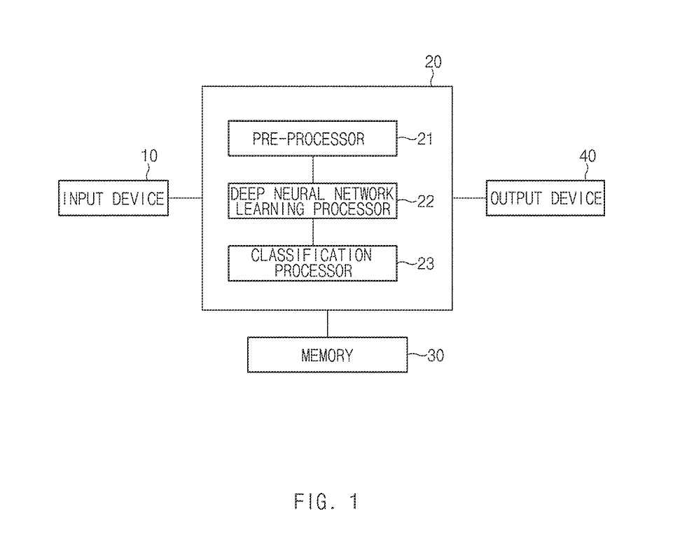

FIG. 1 is a block diagram illustrating a beating pattern recognition system according to an exemplary embodiment of the present disclosure.

Referring to FIG. 1, the beating pattern recognition system according to an exemplary embodiment of the present disclosure may include an input device 10, a processor 20, a memory 30, and an output device 40.

The input device 10 may receive a beating input signal from a user or a noise signal in a vehicle. The input device may include a microphone. The beating input signal may include a beating pattern that is output as a final result. For instance, the beating input signal may include a knocking, touching, or tapping pattern generated by using a finger joint (knuckle), a fist, an elbow, or a fingertip.

The processor 20 may include a preprocessor 21, a deep neural network learning processor 22, and a classification processor 23. The preprocessor 21, the deep neural network learning processor 22, and the classification processor 23 are electric circuitries which perform various functions described below by execution of instructions embedded therein or stored in the memory 30.

The pre-processor 21 may preprocess a signal input thereto using a log power spectra (LPS) as a spectrum analysis technology. That is, the preprocessor 21 may separate the input signal in the unit of frame, determine only frames in a predetermined range of front and rear with respect to a frame, in which an energy of the input signal is highest, as valid signals, and perform Fourier transform on the valid signal to generate a preprocessed signal. According to the exemplary embodiment, only four frames of front and rear with respect to the frame having the highest energy may be determined as the valid signals.

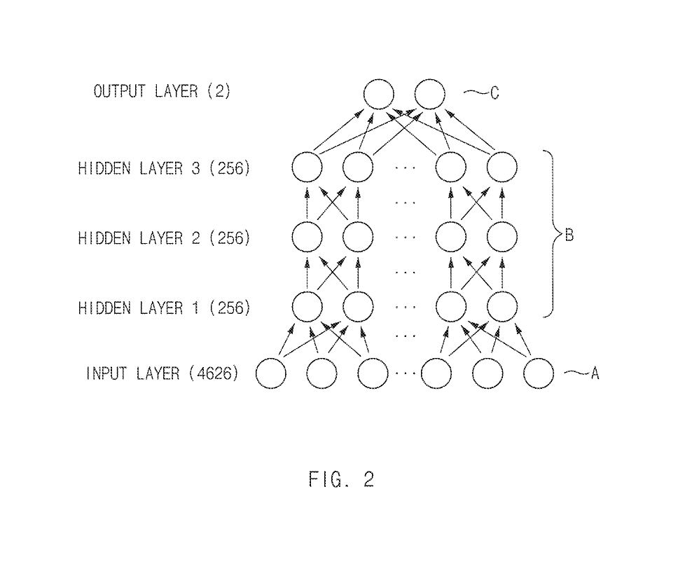

The deep neural network (DNN) learning processor 22 may include a plurality of deep neural networks learned to classify input types of the input signals. The deep neural networks may include first, second, third, and fourth deep neural networks 22a, 22b, 22c, and 22d, and details thereof will be described later. In addition, the deep neural network learning processor 22 may relearn results of the input types of the input signal to increase an amount of learning. Detailed descriptions of the deep neural network learning processor 22 will be described with reference to FIG. 2.

FIG. 2 is a schematic view illustrating a deep neural network according to an exemplary embodiment of the present disclosure.

Referring to FIG. 2, the deep neural network may include one input layer A, three hidden layers B, and one output layers C. A 4626-dimensional preprocessed signal may be input to the input layer A by extracting sequence data of nine frames, each having 257 dimensions, from each of two sensors. Each of the three hidden layers B may have 256 nodes, and the number of nodes of the output layer C may be varied depending on the number of classification results that are to be classified.

The first deep neural network 22a may set the number of the nodes of the output layer to two to classify the input signal into results having features greatly different from each other and proceed with learning to classify the beating input signal or the noise input signal.

The second deep neural network 22b may set the number of the nodes of the output layer of the deep neural network to two to classify the beating input signal into an internal input or an external input and proceed with learning to classify an internal input signal and an external input signal.

The third deep neural network 22c may set the number of the nodes of the output layer to three to classify whether the beating input signal is generated by the finger joint, the fist, or the elbow in a case that the beating input signal is the external input and may proceed with learning to classify the external signal.

The fourth deep neural network 22d may set the number of the nodes of the output layer to two to classify whether the beating input signal is generated by the finger joint or the fingertip in a case that the beating input signal is the internal input and may proceed with learning to classify the internal signal.

The deep neural network learning processor 22 does not learn the deep neural network to classify the beating input signal as the final result all at once. That is, the deep neural network learning processor 22 may learn the deep neural networks such that each deep neural network may classify the input signal with respect to the input types having different references from each other, and thus each deep neural network may be simplified. Accordingly, the deep neural network having a relatively simple structure may be configured, and the deep neural network having the simplified structure may classify the beating pattern into detailed input type, thereby improving a recognition accuracy with respect to the beating pattern.

A signal obtained by preprocessing the beating input signal or a signal obtained by preprocessing the noise signal, which is recorded in real environment, may be input to the deep neural network to learn the deep neural network. In a case that the number of data input to the deep neural networks is insufficient or the number of data input to one deep neural network is different from the number of data input to another deep neural network, the deep neural network may proceed with learning after duplicating the data or adding the noise signal such that the number of data becomes uniform. According to the exemplary embodiment, a rectified linear unit (ReLU) activation function or a drop-out may be applied to the deep neural network for the learning of the deep neural network.

The classification processor 23 may classify the signal input to the input device 10 based on the learned content of each deep neural network.

According to the exemplary embodiment, the classification processor 23 may perform a primary classification on the beating pattern with respect to features greatly different from each other, and then the classification processor 23 may perform a secondary classification and a tertiary classification thoroughly.

The primary classification may include a classification operation for classifying the beating input signal generated by the user and the noise signal generated inside and outside the vehicle using the first deep neural network 22a learned to classify the beating input signal generated by the user and the noise signal.

The secondary classification may be performed on the beating input signal generated by the user except for the noise signal classified by the primary classification. The secondary classification may include a classification operation for classifying the beating input signal generated by the user into the external input or the internal input using the second deep neural network 22b learned to classify the beating input signal generated by the user into the external input and the internal input.

The tertiary classification may include a classification operation for the external input and a classification operation for the internal input. In a case that the beating input signal generated by the user is the external input, the tertiary classification may include a classification operation for classifying whether the external input is generated by the finger joint, the fist, or the elbow using the third deep neural network 22c learned to classify the external input with respect to the input type of the input signal.

In addition, in a case that the beating input signal generated by the user is the internal input, the tertiary classification may include a classification operation for classifying whether the internal input is generated by the finger joint or the fingertip using the fourth deep neural network 22d learned to classify the internal input with respect to the input type of the input signal.

The memory 30 may store the learned content and the learned results of the first, second, third, and fourth deep neural networks 22a, 22b, 22c, and 22d gained in classifying the input type of the input signal. The memory 30 may include a flash memory type memory, a hard disk type memory, a multimedia card micro type memory, or a card type memory, for example, an SD memory, an XD memory, or the like.

The output device 40 may output the final result classified by the classification processor 23. The output device may include a display or a speaker. According to the exemplary embodiment, in the case that the input signal is classified as the ‘noise signal’ through the primary classification, the output device 40 may output the result. In the case that the beating input signal by the user is classified as the external input, the output device 40 may output the classification result as one of ‘an external finger joint’, ‘an external fist’, and ‘an external elbow’, and in the case that the beating input signal by the user is classified into the internal input, the output device 40 may output the classification result as either ‘an internal finger joint’ or ‘an internal fingertip’.

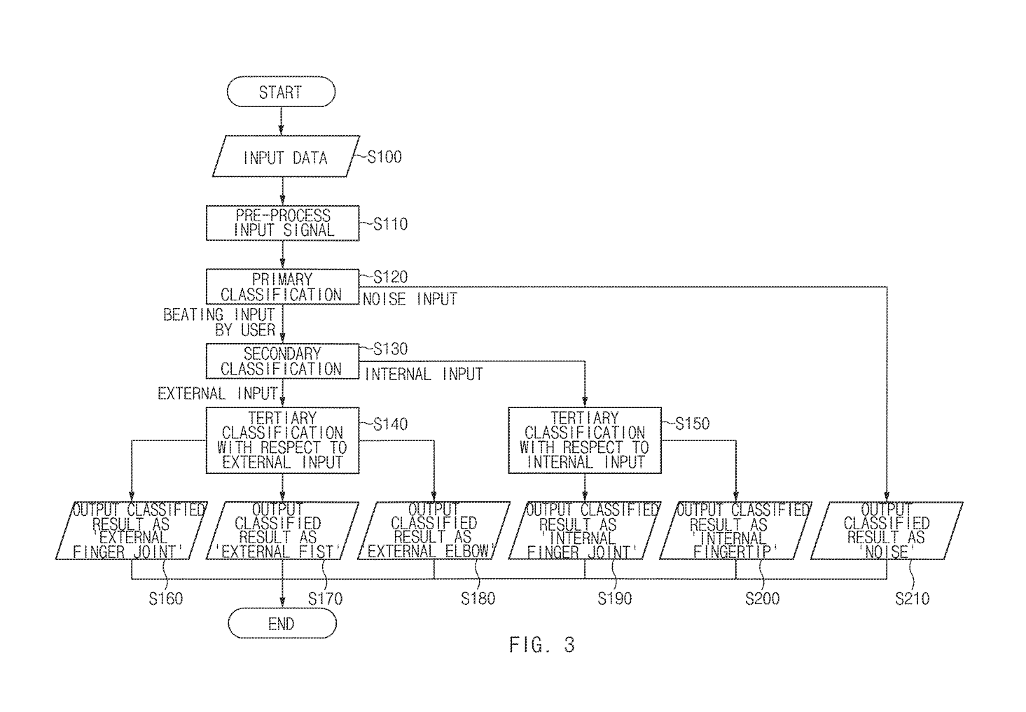

FIG. 3 is a flowchart illustrating a method of recognizing a beating pattern according to an exemplary embodiment of the present disclosure.

Referring to FIG. 3, one of the beating input signal by the user and the noise signal may be input to the input device 10 (S100). Then, the preprocessor 21 may preprocess the signal input thereto using the log power spectra (LPS) as the spectrum analysis technology (S110). In operation S110, the preprocessor 21 may separate the input signal in the unit of frame, determine frames in the predetermined range of front and rear with respect to the frame, in which the energy of the input signal is highest, as the valid signals, and perform Fourier transform on the valid signal to generate the preprocessed signal. According to the exemplary embodiment, only four frames of front and rear with respect to the frame having the highest energy may be determined as the valid signals.

The classification processor 23 may perform the primary classification on the input signal based on information learned by the first deep neural network (S120). The primary classification may include the classification with respect to features greatly different from each other. According to the exemplary embodiment, the primary classification may classify the beating input signal by the user and the noise signal. In the case that the input signal is classified as the beating input signal, operation 130 may be performed. In the case that the input signal is classified as the noise signal, the classified result may be output as ‘noise’ (S210).

Then, the classification processor 23 may perform the secondary classification on the beating input signal based on information of the second deep neural network, which is learned by the deep neural network learning processor 22 (S130). The secondary classification may be performed on the beating input signal by the user except for the noise signal classified by the primary classification and may classify the beating input signal into the external input or the internal input. In the case that the beating input signal is classified as the external input, the tertiary classification may be performed on the external input (S140). In the case that the beating input signal is classified as the internal input, the tertiary classification may be performed on the internal input (S150).

The output device 40 may output the result obtained by performing the tertiary classification on the external input as one of the ‘external finger joint’(S160), the ‘external fist’ (S170), and the ‘external elbow’ (S180). The output device 40 may output the result obtained by performing the tertiary classification on the internal input as the ‘internal finger joint’(S190) or the ‘internal fingertip’(S200). The above-described output results should not be limited thereto or thereby.

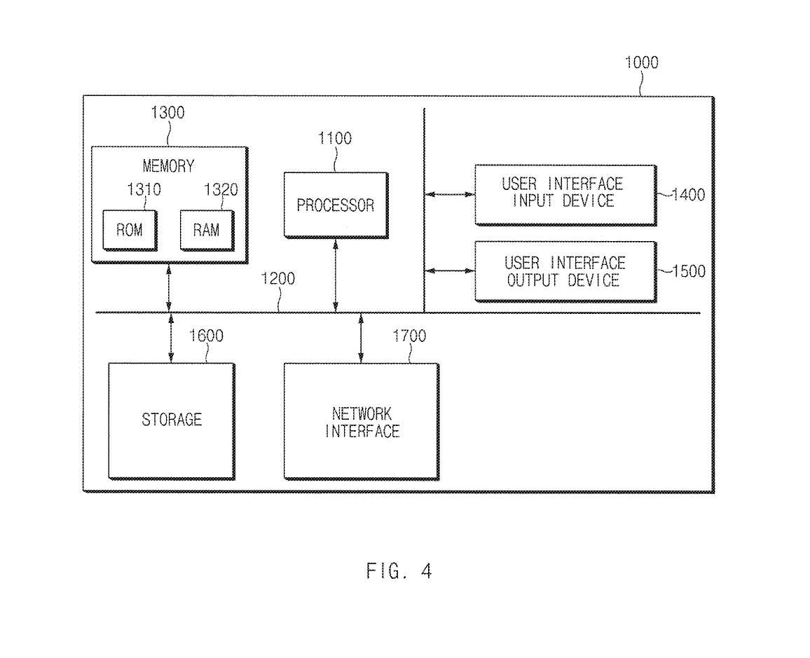

FIG. 4 is a block diagram illustrating a configuration of a computing system that executes a method for recognizing the beating pattern according to an exemplary embodiment of the present disclosure.

Referring to FIG. 4, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only memory (ROM) and a random access memory (RAM).

Thus, the operations of the methods or algorithms described in connection with the embodiments disclosed in the specification may be directly implemented with a hardware module, a software module, or combinations thereof, executed by the processor 1100. The software module may reside on a storage medium (i.e., the memory 1300 and/or the storage 1600), such as a RAM, a flash memory, a ROM, an erasable and programmable ROM (EPROM), an electrically EPROM (EEPROM), a register, a hard disc, a removable disc, or a compact disc-ROM (CD-ROM). The storage medium may be coupled to the processor 1100. The processor 1100 may read out information from the storage medium and may write information in the storage medium. Alternatively, the storage medium may be integrated with the processor 1100. The integrated processor and storage medium may reside in an application specific integrated circuit (ASIC). The ASIC may reside in a user terminal. Alternatively, the integrated processor and storage medium may reside as a separate component of the user terminal.

In the present disclosure, the deep neural network learned to classify the input signal into results having features greatly different from each other and the deep neural network learned to classify the results into results having features with little different from each other are separately provided from each other, and thus the beating pattern may be easily recognized, and each deep neural network may be simplified. In addition, the deep neural network may classify the beating signal by the user or the noise signal generated in the vehicle and provide services to meet the user's needs.

While the present disclosure has been described with reference to exemplary embodiments, it will be apparent to those skilled in the art that various changes and modifications may be made without departing from the spirit and scope of the present disclosure.

Therefore, exemplary embodiments of the present disclosure are not limiting, but illustrative, and the spirit and scope of the present disclosure is not limited thereto. The spirit and scope of the present disclosure should be interpreted by the following claims, and it should be interpreted that all technical ideas which are equivalent to the present disclosure are included in the spirit and scope of the present disclosure.

What is claimed is:

1. A beating pattern recognition system comprising:
a preprocessor configured to preprocess an input signal;
a deep neural network learning processor configured to comprise a plurality of deep neural networks and to perform learning to classify an input type of the input signal; and
a classification processor configured to classify the input type of the preprocessed input signal using the learned deep neural network.

2. The beating pattern recognition system of claim 1, wherein the preprocessor is further configured to preprocess the input signal using a log power spectra (LPS) as a spectrum analysis technology.

3. The beating pattern recognition system of claim 1, wherein the preprocessor is further configured to determine frames in a predetermined range of front and rear with respect to a frame, in which an energy of the input signal is highest, as valid signals.

4. The beating pattern recognition system of claim 1, wherein the deep neural network learning processor is further configured to relearn a result of the input type of the input signal classified by the classification processor.

5. The beating pattern recognition system of claim 1, wherein the deep neural network is further configured to learn the classification of the input signal using a rectified linear unit (ReLU) activation function or a drop-out.

6. The beating pattern recognition system of claim 1, wherein the deep neural network comprises an input layer, a hidden layer, and an output layer, and a number of nodes of the output layer is varied depending on a number of results that are to be classified by the classification processor.

7. The beating pattern recognition system of claim 1, wherein the classification processor is further configured to:
perform a primary classification that classifies the input signal into a beating input signal by a user and a noise signal;
perform a secondary classification that classifies signals classified as the beating input signal by the user in the primary classification into one of an external input and an internal input; and
perform a tertiary classification that classifies each of the external input and the internal input with respect to the input type of the input signal.

8. The beating pattern recognition system of claim 7, wherein the deep neural network learning processor is further configured to duplicate data comprising the input signal or to add the noise signal to the data such that a number of the data becomes uniform in each of the primary, secondary, and tertiary classifications to learn the deep neural network.

9. The beating pattern recognition system of claim 7, wherein the deep neural network is further configured to learn such that the deep neural network classifies the input signal with respect to different references in each of the primary, secondary, and tertiary classifications.

10. The beating pattern recognition system of claim 7, wherein the tertiary classification is further configured to classify the external input with respect to the input type into one of a finger joint, a fist, and an elbow.

11. The beating pattern recognition system of claim 7, wherein the tertiary classification is further configured to classify the internal input with respect to the input type into one of a finger joint and a fingertip.

12. A beating pattern recognition method comprising steps of:
preprocessing, by a processor, an input signal;
learning, by the processor, a plurality of deep neural networks to classify an input type of the input signal; and
classifying, by the processor, the input type of the preprocessed input signal using the learned deep neural network.

13. The method of claim 12, wherein the preprocessing the input signal comprises preprocessing the input signal using a log power spectra (LPS) as a spectrum analysis technology.

14. The method of claim 12, wherein the step of preprocessing the input signal comprises determining frames in a predetermined range of front and rear with respect to a frame, in which an energy of the input signal is highest, as valid signals.

15. The method of claim 12, wherein the step of classifying the input type of the input signal comprises:
primarily classifying the input signal into a beating input signal by a user and a noise signal;
secondarily classifying signals classified as the beating input signal by the user in the primary classification into one of an external input and an internal input; and
tertiarily classifying each of the external input and the internal input with respect to the input type of the input signal.

16. The method of claim 15, wherein the step of tertiarily classifying comprises classifying the external input with respect to the input type into one of a finger joint, a fist, and an elbow.

17. The method of claim 15, wherein the step of tertiarily classifying comprises classifying the internal input with respect to the input type into one of a finger joint and a fingertip.

18. The method of claim 12, wherein the step of learning to classify the input type of the input signal comprises relearning a result of the input type of the classified input signal.

19. The method of claim 12, wherein the step of learning to classify the input type of the input signal comprises learning classification of the input signal using a rectified linear unit (ReLU) activation function or a drop-out.

20. The method of claim 15, wherein the learning to classify the input type of the input signal comprises duplicating data comprising the input signal or adding the noise signal to the data such that the number of the data becomes uniform in each of the primary, secondary, and tertiary classifications to learn the deep neural network.
